(19) United States
(12) Patent Application Publication
(10) Pub. No.: US 2024/0311211 A1
(43) Pub. Date: Sep. 19, 2024

(54) SYSTEMS AND METHODS FOR COMPONENT MESSAGING

(71) Applicant: Engineer.ai Corp., Salt Lake City, UT (US)

(72) Inventors: Sachin Dev Duggal, Salt Lake City, UT (US); Joseph Rifkin, Salt Lake City, UT (US); Rohan Patel, London (GB)

(73) Assignee: Engineer.ai Corp., Salt Lake City, UT (US)

(21) Appl. No.: 18/325,026

(22) Filed: May 29, 2023

Related U.S. Application Data
(60) Provisional application No. 63/489,817, filed on Mar. 13, 2023.

(51) Int. Cl. G06F 9/54; G06F 8/30

(52) U.S. Cl. CPC G06F 9/541; G06F 8/30

(57) ABSTRACT

A device may receive an output from a building block component of a multitude of building block components, each of the multitude of building block components are ignorant of processes of other building block components. The device may translate the output, with a component adapter of a multitude of adaptors, into a message that is receivable by at least one of the multitude of adaptors. The device may store a state of the device application based on the output, the state is accessible by the multitude of adapters where the multitude of building block components are capable of receiving the message via the multitude of adaptors.

### CROSS REFERENCE TO PRIOR APPLICATION

This application claims the benefit of U.S. Provisional Patent Application No. 63/489,817, entitled as “Systems and Methods for Component Messaging”, filed Mar. 13, 2023, which is incorporated by reference in its entirety.

### FIELD OF THE INVENTION

This disclosure relates to software automation, machine learning AI, and project management.

### BACKGROUND

Modern software often requires data or input provided from another piece of software or code, and may be required to pass on data or output to another piece of software or code. These could be simple functions or other pieces of software which must work concurrently and pass information between different pieces of software, such as variables, tokens, or other information.

Any data transferred between pieces of software must be accurate and sent within the proper time frame. Any errors may result in errors during software execution. There is a need in the art for a better way to transfer information between pieces of software.

### SUMMARY

The disclosed subject matter describes systems, methods, and computer readable storage media for component messaging. An exemplary embodiment relates to a method for operating a device application, the method including: receiving an output from a building block component of a multitude of building block components, each of the multitude of building block components are ignorant of processes of other building block components; translating the output, with a component adapter of a multitude of adaptors, into a message that is receivable by at least one of the multitude of adaptors; storing a state of the device application based on the output, the state is accessible by the multitude of adapters; and the multitude of building block components are capable of receiving the message via the multitude of adaptors. The multitude of adaptors may include a customer logic section that is configurable to execute one or more functions of the multitude of building block components. The message may be transmitted on a channel that is selectable by the adaptor. The method may further include subscribing, by at least one of the multitude of adaptors, to a topic on the channel; and wherein the message includes the topic. The custom logic section may be configurable to execute a function of at least one of the multitude of building block components responsive to receiving the message. The custom logic section may be configurable by a machine readable specification. The method may further include executing, by one of the multitude of adaptors, a function of one of the multitude of building block components responsive to receiving the message.

Another general aspect relates to a computer system configured to develop a device application, the computer system including: a processor coupled to a memory, the processor configured to: receive an output from a building block component of a multitude of building block components, each of the multitude of building block components are ignorant of processes of other building block components; translate the output, with a component adapter of a multitude of adaptors, into a message that is receivable by at least one of the multitude of adaptors; and store a state of the device application based on the output, the state is accessible by the multitude of adapters; the multitude of building block components are capable of receiving the message via the multitude of adaptors. The multitude of adaptors may include a customer logic section that is configurable to execute one or more functions of the multitude of building block components. The message may be transmitted on a channel that is selectable by the component adaptor. The processor may be further configured to subscribe, by at least one of the multitude of adaptors, to a topic on the channel; and wherein the message includes the topic. The custom logic section may be configurable to execute a function of at least one of the multitude of building block components responsive to receiving the message. The custom logic section may be configurable by a machine readable specification. The processor may be further configured to execute, by one of the multitude of adaptors, a function of one of the multitude of building block components responsive to receiving the message.

An exemplary embodiment is a computer readable storage medium having data stored therein representing software executable by a computer, the software including instructions that, when executed, cause the computer readable storage medium to perform: receiving an output from a building block component of a multitude of building block components, each of the multitude of building block components are ignorant of processes of other building block components; translating the output, with a component adapter of a multitude of adaptors, into a message that is receivable by at least one of the multitude of adaptors; storing a state of a device application based on the output, the state is accessible by the multitude of adapters; and the multitude of building block components are capable of receiving the message via the multitude of adaptors. The multitude of adaptors may include a customer logic section that is configurable to execute one or more functions of the multitude of building block components. The message may be transmitted on a channel that is selectable by the adaptor. The instructions may further cause the computer readable storage medium to perform subscribing, by at least one of the multitude of adaptors, to a topic on the channel and where the message includes the topic. The custom logic section is configurable to execute a function of at least one of the multitude of building block components responsive to receiving the message. The instructions may further cause the computer readable storage medium to perform executing, by one of the multitude of adaptors, a function of one of the multitude of building block components responsive to receiving the message.

Another general aspect is a method for operating a device application, the method including: receiving, by a device application containing a multitude of adaptors and a multitude of building block components, a building block component that is configured to perform a function; receiving an output from the building block component; translating, by an adaptor of the multitude of adaptors, the output from the building block component into a message that is receivable by the multitude of adaptors; and storing, based on the output, one or more states of the device application in a database that is accessible by the multitude of adaptors in the device application. The method may further include subscribing, by at least one of the multitude of adaptors, to the message. Translating may include transmitting the message on a channel; and wherein subscribing includes selecting a channel to listen for the message. The at least one adaptor of the multitude of adaptors may include a custom logic section. The custom logic section may be configurable to execute a function of at least one of the multitude of building block components responsive to receiving the message. The custom logic section may be configurable by a machine readable specification. Each of the multitude of building block components may include one or more functions that are ignorant of functions of other building block components.

An exemplary embodiment is a computer system configured to develop a device application, the computer system including: a processor coupled to a memory, the processor configured to: receiving, by a device application containing a multitude of adaptors and a multitude of building block components, a building block component that is configured to perform a function; receiving an output from the building block component; translating, by an adaptor of the multitude of adaptors, the output from the building block component into a message that is receivable by the multitude of adaptors; and storing, based on the output, one or more states of the device application in a database that is accessible by the multitude of adaptors in the device application. The processor may be further configured to subscribe, by at least one of the multitude of adaptors, to the message. Translate may include the processor configured to transmit the message on a channel; and wherein subscribe includes the processor configured to select a channel to listen for the message. The at least one adaptor of the multitude of adaptors may include a custom logic section. The custom logic section may be configurable to execute a function of at least one of the multitude of building block components responsive to receiving the message. The custom logic section may be configurable by a machine readable specification. Each of the multitude of building block components may include one or more functions that are ignorant of functions of other building block components.

Another general aspect is a computer readable storage medium having data stored therein representing software executable by a computer, the software including instructions that, when executed, cause the computer readable storage medium to perform: receiving, by a device application containing a multitude of adaptors and a multitude of building block components, a building block component that is configured to perform a function; receiving an output from the building block component; translating, by an adaptor of the multitude of adaptors, the output from the building block component into a message that is receivable by the multitude of adaptors; and storing, based on the output, one or more states of the device application in a database that is accessible by the multitude of adaptors in the device application. The instructions may further cause the computer readable storage medium to perform subscribing, by at least one of the multitude of adaptors, to the message. Translating may include transmitting the message on a channel; and wherein subscribing includes selecting a channel to listen for the message. The at least one adaptor of the multitude of adaptors may include a custom logic section. The custom logic section may be configurable to execute a function of at least one of the multitude of building block components responsive to receiving the message. The custom logic section may be configurable by a machine readable specification.

An exemplary embodiment is a method of operating a device application, the method including: executing a function, by at least one of a multitude of building block components; transmitting, by a run engine responsive to the function, one or more messages that are generated by at least one of a multitude of adaptors; receiving the message by at least one of the multitude of adaptors; and executing a function of at least one of a multitude of building block components responsive to receiving the message, the multitude of building block components, including one or more functions, are ignorant of other building block components. The multitude of component adaptors may include a custom logic section that is configurable to execute one or more functions of the multitude of building block components. The custom logic section may be configurable to execute a function of at least one of the multitude of building block components responsive to receiving the message. The custom logic section is configurable by a machine readable specification. The method may further include storing a state of the run engine responsive to the message. The state may be retrievable by at least one of the multitude of adaptors. The message may be transmitted on a channel that is selectable by the component adaptor. The method may further include subscribing, by at least one of the multitude of adaptors, to a topic on the channel; and wherein the message includes a topic.

Another general aspect is a computer system configured to develop a device application, the computer system including: a processor coupled to a memory, the processor configured to: execute a function, by at least one of a multitude of building block components; transmit, by a run engine responsive to the function, one or more messages that are generated by at least one of a multitude of adaptors; receive the message by at least one of the multitude of adaptors; and execute a function of at least one of a multitude of building block components responsive to receiving the message, the multitude of building block components, including one or more functions, are ignorant of other building block components. The multitude of component adaptors may include a custom logic section that is configurable to execute one or more functions of the multitude of building block components. The custom logic section may be configurable to execute a function of at least one of the multitude of building block components responsive to receiving the message. The custom logic section may be configurable by a machine readable specification. The processor may be further configured to store a state of the run engine responsive to the message. The state may be retrievable by at least one of the multitude of adaptors. The message may be transmitted on a channel that is selectable by the component adaptor. The processor may be further configured to subscribe, by at least one of the multitude of adaptors, to a topic on the channel; and wherein the message includes a topic.

An exemplary embodiment is a computer readable storage medium having data stored therein representing software executable by a computer, the software including instructions that, when executed, cause the computer readable storage medium to perform: executing a function, by at least one of a multitude of building block components; transmitting, by a run engine responsive to the function, one or more messages that are generated by at least one of a multitude of adaptors; receiving the message by at least one of the multitude of adaptors; and executing a function of at least one of a multitude of building block components responsive to receiving the message, the multitude of building block components, including one or more functions, are ignorant of other building block components, the multitude of component adaptors may include a custom logic section that is configurable to execute one or more functions of the multitude of building block components. The custom logic section may be configurable to execute a function of at least one of the multitude of building block components responsive to receiving the message. The custom logic section may be configurable by a machine readable specification; where the instructions further cause the computer readable storage medium to perform storing a state of the run engine responsive to the message; and wherein the state is retrievable by at least one of the multitude of adaptors.

### BRIEF DESCRIPTION OF THE DRAWINGS

FIG. 1 is a software building system illustrating the components that may be used in an embodiment of the disclosed subject matter.

FIG. 2 is a schematic illustrating an embodiment of the management components of the disclosed subject matter.

FIG. 3 is a schematic illustrating an embodiment of an assembly line and surfaces of the disclosed subject matter.

FIG. 4 is a schematic illustrating an embodiment of the run entities of the disclosed subject matter.

FIG. 5 is a schematic illustrating an embodiment of a run engine of the disclosed subject matter facilitating communication between various components of a device application.

FIG. 6A is a schematic for an embodiment of a run engine of the disclosed subject matter.

FIG. 6B is a schematic for an embodiment of a building block that may be implemented in the disclosed subject matter.

FIG. 6C is a schematic for an embodiment of an adapter that may be implemented in the disclosed subject matter.

FIG. 7 is a flow diagram of communication between software modules in the disclosed subject matter.

FIG. 8 is a flow diagram showing communication from a building block component to other building block components.

FIG. 9 is a flow diagram illustrating a device application that incorporates a new building block component.

FIG. 10 is a flow diagram showing how building block components, that are ignorant of one another, may execute functions responsive to other building block components.

FIG. 11 is a schematic illustrating the computing components that may be used to implement various features of embodiments described in the disclosed subject matter.

### DETAILED DESCRIPTION

The disclosed subject matter are computer systems and methods to generate a device application. The application engine, referred to herein as a run engine, is a device application component that is configured to facilitate interaction between a multitude of components that are ignorant of one another. The term component, as used herein, may refer to a sequence of instructions that perform a task or function. As used herein, the term, building block component refers to a component that performs functions in a run engine. The terms component and building block component may be used interchangeably. In various embodiments, components are configured to be reusable and interchangeable. The term function, as used herein, may refer to any function, subroutine, module, class, entity, component, or the like in a software environment.

In various embodiments, the various components that are configured to run a software application are ignorant of one another. The term ignorant, as used herein, refers to a component that is self-contained and operates without dependencies to other components in the same device application. Accordingly, one or more components may operate independently of other components. The run engine may be configured to manage the operation of the various ignorant components to perform one or more functions of the device application.

In various embodiments, the run engine may include logic that facilitates the operation of the various components of a device application. For example, the run engine may include logic that determines when various functions of components are executed. Logic in the run engine may cause a first component to execute a set of instructions responsive to an output from a second component. Even though the two components are ignorant of one another, the run engine may cause the two components to operate in coordination with one another.

In an exemplary embodiment, the run engine may incorporate one or more adapters that are configured to include logic that facilitates the coordination of input and output from the various components in a device application. In various embodiments, an adapter may be configured to translate an output from a component to be broadcast to other components. In various embodiments, an adapter may be configured to translate a message that is broadcast by another adapter so that the message may be received by any component that is listening for the message. A single adapter may be configured to translate outgoing or ingoing messages for one or more components. Similarly, multiple adapters may be configured to translate outgoing or ingoing messages from a single component. An adapter may include logic that causes it to perform an action responsive to a function or message. For example, an adapter may be configured to broadcast a message responsive to execution of a function by a component. In another example, an adapter may be configured to cause a component to execute one or more functions responsive to receiving a message that is broadcast by another component.

In addition to facilitating messaging between various components of a device application, the run engine may also perform the functions of a transaction dispatcher. The term transaction dispatcher, as used herein, refers to a set of operations or functions that are performed together as a single unit. In an example of use, an adapter may be configured to broadcast a message to a channel. One or more other adapters may be subscribed to the channel and be configured to cause one or more components to execute functions that are responsive to receiving the message on the channel. The term channel, as used herein is a stream of data for announcing messages. An adapter may selectively subscribe to one or more channels to listen for messages. Additionally, the run engine may act as a rest API client that enables a component, application, or service to access the device application. In an exemplary embodiment, any component may perform a rest request and it may be accepted. For example, third party service may request a state of a device application by accessing a rest API. For instance, a service may request a login state of a device application. The run engine may respond to the request with a response of “LOGGED IN” or “NOT LOGGED IN”.

Additionally, the run engine may handle direct screen to screen navigation in a device application. For example, the run engine may determine which screen to display for a device application. The term screen, as used herein refers to a scene, display, or the like that is displayed on the screen of a device. For example, a device application may display a menu screen, a login screen, an input screen, or various other screens that facilitate a functionality of the device application. In an exemplary embodiment, the run engine may cause the device application to navigate one screen to another screen responsive to a message or broadcast by one or more adapters.

Additionally, the run engine may act as a session manager of a device application. Accordingly, the run engine may handle maintenance, tracking, and creation of user sessions. For example, the run engine may receive a message to begin a user session whereby the run engine will initiate the user session. Similarly, the run engine may initiate any modifications to the user session responsive to messages that it receives.

Additionally, the run engine may handle user account management for a device application. For example, the run engine may store user information and maintain an account status for one or more users. An example of user information may include a username in one or more applications for which the user is authorized to use. An account status may similarly include user login information as well as whether a user is authorized to use the one or more applications.

Additionally, the run engine may include a state machine. The state machine may set one or more states that may persist across the device application. The state machine may announce the state to different screens of the device application. An example of a state may be a login state for the device application. One or more adapters may request a login state of the device application from the run engine. The run engine may respond with a “LOGGED IN” or “LOGGED OUT” login state. The state machine of the run engine may store any number of states. The stored states may be available to all adapters and/or components of the device application. In various embodiments, the state machine may broadcast or announce a state to various adapters or components without prompting or a message. For example, the run engine may be configured to announce a screen change to the device application whenever the run engine changes screens for the device application. In one instance of the example, the state machine may announce that the device application changed from a menu screen to a browsing screen.

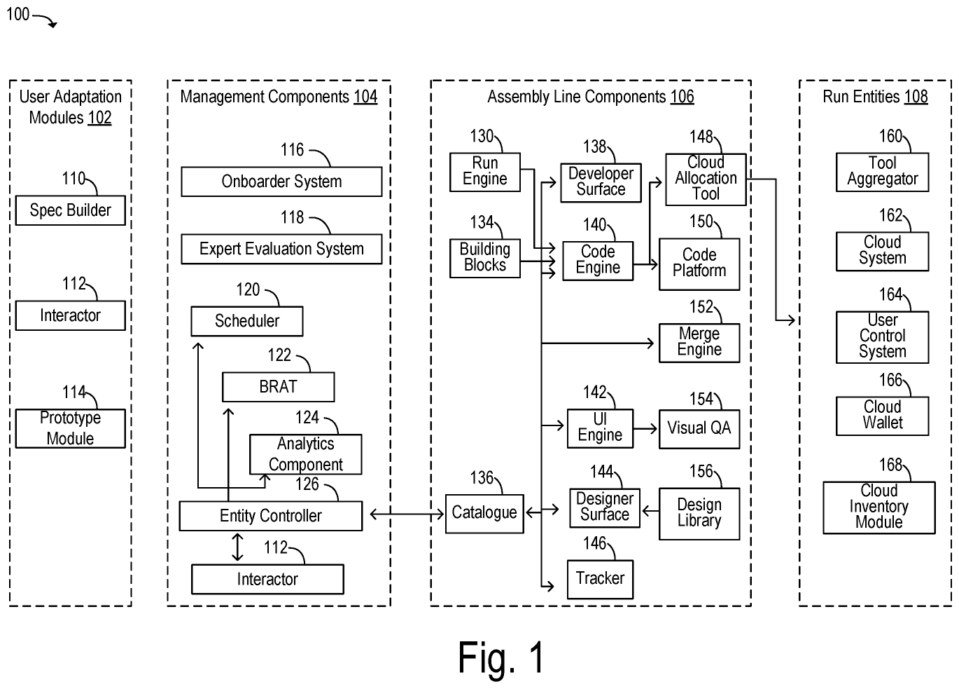

Referring to FIG. 1, FIG. 1 is a schematic of a software building system 100 illustrating the components that may be used in an embodiment of the disclosed subject matter. The software building system 100 is an AI-assisted platform that comprises entities, circuits, modules, and components that enable the use of state-of-the-art algorithms to support producing custom software.

A user may leverage the various components of the software building system 100 to quickly design and complete a software project. The features of the software building system 100 operate AI algorithms where applicable to streamline the process of building software. Designing, building and managing a software project may all be automated by the AI algorithms.

To begin a software project, an intelligent AI conversational assistant may guide users in conception and design of their idea. Components of the software building system 100 may accept plain language specifications from a user and convert them into a computer readable specification that can be implemented by other parts of the software building system 100. Various other entities of the software building system 100 may accept the computer readable specification or buildcard to automatically implement it and/or manage the implementation of the computer readable specification.

The embodiment of the software building system 100 shown in FIG. 1 includes user adaptation modules 102, management components 104, assembly line components 106, and run entities 108. The user adaptation modules 102 entities guide a user during all parts of a project from the idea conception to full implementation, user adaptation modules 102 may intelligently link a user to various entities of the software building system 100 based on the specific needs of the user.

The user adaptation modules 102 may include specification builder 110, an interactor 112 system, and the prototype module 114. They may be used to guide a user through a process of building software and managing a software project. Specification builder 110, the interactor 112 system, and the prototype module 114 may be used concurrently and/or link to one another. For instance, specification builder 110 may accept user specifications that are generated in an interactor 112 system. The prototype module 114 may utilize computer generated specifications that are produced in specification builder 110 to create a prototype for various features. Further, the interactor 112 system may aid a user in implementing all features in specification builder 110 and the prototype module 114.

Spec builder 110 converts user supplied specifications into specifications that can be automatically read and implemented by various objects, instances, or entities of the software building system 100. The machine readable specifications may be referred to herein as a buildcard. In an example of use, specification builder 110 may accept a set of features, platforms, etc., as input and generate a machine readable specification for that project. Specification builder 110 may further use one or more machine learning algorithms to determine a cost and/or timeline for a given set of features. In an example of use, specification builder 110 may determine potential conflict points and factors that will significantly affect cost and timeliness of a project based on training data. For example, historical data may show that a combination of various building block components create a data transfer bottleneck. Specification builder 110 may be configured to flag such issues.

The interactor 112 system is an AI powered speech and conversational analysis system. It converses with a user with a goal of aiding the user. In one example, the interactor 112 system may ask the user a question to prompt the user to answer about a relevant topic. For instance, the relevant topic may relate to a structure and/or scale of a software project the user wishes to produce. The interactor 112 system makes use of natural language processing (NLP) to decipher various forms of speech including comprehending words, phrases, and clusters of phases

In an exemplary embodiment, the NLP implemented by interactor 112 system is based on a deep learning algorithm. Deep learning is a form of a neural network where nodes are organized into layers. A neural network has a layer of input nodes that accept input data where each of the input nodes are linked to nodes in a next layer. The next layer of nodes after the input layer may be an output layer or a hidden layer. The neural network may have any number of hidden layers that are organized in between the input layer and output layers.

Data propagates through a neural network beginning at a node in the input layer and traversing through synapses to nodes in each of the hidden layers and finally to an output layer. Each synapse passes the data through an activation function such as, but not limited to, a Sigmoid function. Further, each synapse has a weight that is determined by training the neural network. A common method of training a neural network is backpropagation. Backpropagation is an algorithm used in neural networks to train models by adjusting the weights of the network to minimize the difference between predicted and actual outputs. During training, backpropagation works by propagating the error back through the network, layer by layer, and updating the weights in the opposite direction of the gradient of the loss function. By repeating this process over many iterations, the network gradually learns to produce more accurate outputs for a given input.

Various systems and entities of the software building system 100 may be based on a variation of a neural network or similar machine learning algorithm. For instance, input for NLP systems may be the words that are spoken in a sentence. In one example, each word may be assigned to separate input node where the node is selected based on the word order of the sentence. The words may be assigned various numerical values to represent word meaning whereby the numerical values propagate through the layers of the neural network.

The NLP employed by the interactor 112 system may output the meaning of words and phrases that are communicated by the user. The interactor 112 system may then use the NLP output to comprehend conversational phrases and sentences to determine the relevant information related to the user's goals of a software project. Further machine learning algorithms may be employed to determine what kind of project the user wants to build including the goals of the user as well as providing relevant options for the user.

The prototype module 114 can automatically create an interactive prototype for features selected by a user. For instance, a user may select one or more features and view a prototype of the one or more features before developing them. The prototype module 114 may determine feature links to which the user's selection of one or more features would be connected. In various embodiments, a machine learning algorithm may be employed to determine the feature links. The machine learning algorithm may further predict embeddings that may be placed in the user selected features.

An example of the machine learning algorithm may be a gradient boosting model. A gradient boosting model may use successive decision trees to determine feature links. Each decision tree is a machine learning algorithm in itself and includes nodes that are connected via branches that branch based on a condition into two nodes. Input begins at one of the nodes whereby the decision tree propagates the input down a multitude of branches until it reaches an output node. The gradient boosted tree uses multiple decision trees in a series. Each successive tree is trained based on errors of the previous tree and the decision trees are weighted to return best results.

The prototype module 114 may use a secondary machine learning algorithm to select a most likely starting screen for each prototype. Thus, a user may select one or more features and the prototype module 114 may automatically display a prototype of the selected features.

The software building system 100 includes management components 104 that aid the user in managing a complex software building project. The management components 104 allow a user that does not have experience in managing software projects to effectively manage multiple experts in various fields. An embodiment of the management components 104 include the onboarding system 116, an expert evaluation system 118, scheduler 120, BRAT 122, analytics component 124, entity controller 126, and the interactor 112 system.

The onboarding system 116 aggregates experts so they can be utilized to execute specifications that are set up in the software building system 100. In an exemplary embodiment, software development experts may register into the onboarding system 116 which will organize experts according to their skills, experience, and past performance. In one example, the onboarding system 116 provides the following features: partner onboarding, expert onboarding, reviewer assessments, expert availability management, and expert task allocation.

An example of partner onboarding may be pairing a user with one or more partners in a project. The onboarding system 116 may prompt potential partners to complete a profile and may set up contracts between the prospective partners. An example of expert onboarding may be a systematic assessment of prospective experts including receiving a profile from the prospective expert, quizzing the prospective expert on their skill and experience, and facilitating courses for the expert to enroll and complete. An example of reviewer assessments may be for the onboarding system 116 to automatically review completed portions of a project. For instance, the onboarding system 116 may analyze submitted code, validate functionality of submitted code, and assess a status of the code repository. An example of expert availability management in the onboarding system 116 is to manage schedules for expert assignments and oversee expert compensation. An example of expert task allocation is to automatically assign jobs to experts that are onboarded in the onboarding system 116. For instance, the onboarding system 116 may determine a best fit to match onboarded experts with project goals and assign appropriate tasks to the determined experts.

The expert evaluation system 118 continuously evaluates developer experts. In an exemplary embodiment, the expert evaluation system 118 rates experts based on completed tasks and assigns scores to the experts. The scores may provide the experts with valuable critique and provide the onboarding system 116 with metrics with it can use to allocate the experts on future tasks.

Scheduler 120 keeps track of overall progress of a project and provides experts with job start and job completion estimates. In a complex project, some expert developers may be required to wait until parts of a project are completed before their tasks can begin. Thus, effective time allocation can improve expert developer management. Scheduler 120 provides up to date estimates to expert developers for job start and completion windows so they can better manage their own time and position them to complete their job on time with high quality.

The big resource allocation tool (BRAT 122) is capable of generating optimal developer assignments for every available parallel workstream across multiple projects. BRAT 122 system allows expert developers to be efficiently managed to minimize cost and time. In an exemplary embodiment, the BRAT 122 system considers a plethora of information including feature complexity, developer expertise, past developer experience, time zone, and project affinity to make assignments to expert developers. The BRAT 122 system may make use of the expert evaluation system 118 to determine the best experts for various assignments. Further, the expert evaluation system 118 may be leveraged to provide live grading to experts and employ qualitative and quantitative feedback. For instance, experts may be assigned a live score based on the number of jobs completed and the quality of jobs completed.

The analytics component 124 is a dashboard that provides a view of progress in a project. One of many purposes of the analytics component 124 dashboard is to provide a primary form of communication between a user and the project developers. Thus, offline communication, which can be time consuming and stressful, may be reduced. In an exemplary embodiment, the analytics component 124 dashboard may show live progress as a percentage feature along with releases, meetings, account settings, and ticket sections. Through the analytics component 124 dashboard, dependencies may be viewed and resolved by users or developer experts.

The entity controller 126 is a primary hub for entities of the software building system 100. It connects to scheduler 120, the BRAT 122 system, and the analytics component 124 to provide for continuous management of expert developer schedules, expert developer scoring for completed projects, and communication between expert developers and users. Through the entity controller 126, both expert developers and users may assess a project, make adjustments, and immediately communicate any changes to the rest of the development team.

The entity controller 126 may be linked to the interactor 112 system, allowing users to interact with a live project via an intelligent AI conversational system. Further, the Interactor 112 system may provide expert developers with up-to-date management communication such as text, email, ticketing, and even voice communications to inform developers of expected progress and/or review of completed assignments.

The assembly line components 106 comprise underlying components that provide the functionality to the software building system 100. The embodiment of the assembly line components 106 shown in FIG. 1 includes a run engine 130, building block components 134, catalogue 136, developer surface 138, a code engine 140, a UI engine 142, a designer surface 144, tracker 146, a cloud allocation tool 148, a code platform 150, a merge engine 152, visual QA 154, and a design library 156.

The run engine 130 may maintain communication between various building block components within a project as well as outside of the project. In an exemplary embodiment, the run engine 130 may send HTTP/S GET or POST requests from one page to another.

The building block components 134 are reusable code that are used across multiple computer readable specifications. The term buildcards, as used herein, refer tomachine readable specifications that are generated by specification builder 110, which may convert user specifications into a computer readable specification that contains the user specifications and a format that can be implemented by an automated process with minimal intervention by expert developers.

The computer readable specifications are constructed with building block components 134, which are reusable code components. The building block components 134 may be pretested code components that are modular and safe to use. In an exemplary embodiment, every building block component 134 consists of two sections-core and custom. Core sections comprise the lines of code which represent the main functionality and reusable components across computer readable specifications. The custom sections comprise the snippets of code that define customizations specific to the computer readable specification. This could include placeholder texts, theme, color, font, error messages, branding information, etc.

Catalogue 136 is a management tool that may be used as a backbone for applications of the software building system 100. In an exemplary embodiment, the catalogue 136 may be linked to the entity controller 126 and provide it with centralized, uniform communication between different services.

Developer surface 138 is a virtual desktop with preinstalled tools for development. Expert developers may connect to developer surface 138 to complete assigned tasks. In an exemplary embodiment, expert developers may connect to developer surface from any device connected to a network that can access the software project. For instance, developer experts may access developer surface 138 from a web browser on any device. Thus, the developer experts may essentially work from anywhere across geographic constraints. In various embodiments, the developer surface uses facial recognition to authenticate the developer expert at all times. In an example of use, all code that is typed by the developer expert is tagged with an authentication that is verified at the time each keystroke is made. Accordingly, if code is copied, the source of the copied code may be quickly determined. The developer surface 138 further provides a secure environment for developer experts to complete their assigned tasks.

The code engine 140 is a portion of a code platform 150 that assembles all the building block components required by the build card based on the features associated with the build card. The code platform 150 uses language-specific translators (LSTs) to generate code that follows a repeatable template. In various embodiments, the LSTs are pretested to be deployable and human understandable. The LSTs are configured to accept markers that identify the customization portion of a project. Changes may be automatically injected into the portions identified by the markers. Thus, a user may implement custom features while retaining product stability and reusability. In an example of use, new or updated features may be rolled out into an existing assembled project by adding the new or updated features to the marked portions of the LSTs.

In an exemplary embodiment, the LSTs are stateless and work in a scalable Kubernetes Job architecture which allows for limitless scaling that provide the needed throughput based on the volume of builds coming in through a queue system. This stateless architecture may also enable support for multiple languages in a plug & play manner. The cloud allocation tool 148 manages cloud computing that is associated with computer readable specifications. For example, the cloud allocation tool 148 assesses computer readable specifications to predict a cost and resources to complete them. The cloud allocation tool 148 then creates cloud accounts based on the prediction and facilitates payments over the lifecycle of the computer readable specification.

The merge engine 152 is a tool that is responsible for automatically merging the design code with the functional code. The merge engine 152 consolidates styles and assets in one place allowing experts to easily customize and consume the generated code. The merge engine 152 may handle navigations that connect different screens within an application. It may also handle animations and any other interactions within a page.

The UI engine 142 is a design-to-code product that converts designs into browser ready code. In an exemplary embodiment, the UI engine 142 converts designs such as those made in Sketch into React code. The UI engine may be configured to scale generated UI code to various screen sizes without requiring modifications by developers. In an example of use, a design file may be uploaded by a developer expert to designer surface 144 whereby the UI engine automatically converts the design file into a browser ready format.

Visual QA 154 automates the process of comparing design files with actual generated screens and identifies visual differences between the two. Thus, screens generated by the UI engine 142 may be automatically validated by the visual QA 154 system. In various embodiments, a pixel to pixel comparison is performed using computer vision to identify discrepancies on the static page layout of the screen based on location, color contrast and geometrical diagnosis of elements on the screen. Differences may be logged as bugs by scheduler 120 so they can be reviewed by expert developers.

In an exemplary embodiment, visual QA 154 implements an optical character recognition (OCR) engine to detect and diagnose text position and spacing. Additional routines are then used to remove text elements before applying pixel-based diagnostics. At this latter stage, an approach based on similarity indices for computer vision is employed to check element position, detect missing/spurious objects in the UI and identify incorrect colors. Routines for content masking are also implemented to reduce the number of false positives associated with the presence of dynamic content in the UI such as dynamically changing text and/or images.

The visual QA 154 system may be used for computer vision, detecting discrepancies between developed screens, and designs using structural similarity indices. It may also be used for excluding dynamic content based on masking and removing text based on optical character recognition whereby text is removed before running pixel-based diagnostics to reduce the structural complexity of the input images.

The designer surface 144 connects designers to a project network to view all of their assigned tasks as well as create or submit customer designs. In various embodiments, computer readable specifications include prompts to insert designs. Based on the computer readable specification, the designer surface 144 informs designers of designs that are expected of them and provides for easy submission of designs to the computer readable specification. Submitted designs may be immediately available for further customization by expert developers that are connected to a project network.

Similar to building block components 134, the design library 156 contains design components that may be reused across multiple computer readable specifications. The design components in the design library 156 may be configured to be inserted into computer readable specifications, which allows designers and expert developers to easily edit them as a starting point for new designs. The design library 156 may be linked to the designer surface 144, thus allowing designers to quickly browse pretested designs for user and/or editing.

Tracker 146 is a task management tool for tracking and managing granular tasks performed by experts in a project network. In an example of use, common tasks are injected into tracker 146 at the beginning of a project. In various embodiments, the common tasks are determined based on prior projects, completed, and tracked in the software building system 100.

The run entities 108 contain entities that all users, partners, expert developers, and designers use to interact within a centralized project network. In an exemplary embodiment, the run entities 108 include tool aggregator 160, cloud system 162, user control system 164, cloud wallet 166, and a cloud inventory module 168. The tool aggregator 160 entity brings together all third-party tools and services required by users to build, run and scale their software project. For instance, it may aggregate software services from payment gateways and licenses such as Office 365. User accounts may be automatically provisioned for needed services without the hassle of integrating them one at a time. In an exemplary embodiment, users of the run entities 108 may choose from various services on demand to be integrated into their application. The run entities 108 may also automatically handle invoicing of the services for the user.

The cloud system 162 is a cloud platform that is capable of running any of the services in a software project. The cloud system 162 may connect any of the entities of the software building system 100 such as the code platform 150, developer surface 138, designer surface 144, catalogue 136, entity controller 126, specification builder 110, the interactor 112 system, and the prototype module 114 to users, expert developers, and designers via a cloud network. In one example, cloud system 162 may connect developer experts to an IDE and design software for designers allowing them to work on a software project from any device.

The user control system 164 is a system requiring the user to have input over every feature of a final product in a software product. With the user control system 164, automation is configured to allow the user to edit and modify any features that are attached to a software project regardless as to the coding and design by developer experts and designer. For example, building block components 134 are configured to be malleable such that any customizations by expert developers can be undone without breaking the rest of a project. Thus, dependencies are configured so that no one feature locks out or restricts development of other features.

Cloud wallet 166 is a feature that handles transactions between various individuals and/or groups that work on a software project. For instance, payment for work performed by developer experts or designers from a user is facilitated by cloud wallet 166. A user need only set up a single account in cloud wallet 166 whereby cloud wallet handles payments of all transactions.

A cloud allocation tool 148 may automatically predict cloud costs that would be incurred by a computer readable specification. This is achieved by consuming data from multiple cloud providers and converting it to domain specific language, which allows the cloud allocation tool 148 to predict infrastructure blueprints for customers' computer readable specifications in a cloud agnostic manner. It manages the infrastructure for the entire lifecycle of the computer readable specification (from development to after care) which includes creation of cloud accounts, in predicted cloud providers, along with setting up CI/CD to facilitate automated deployments.

The cloud inventory module 168 handles storage of assets on the run entities 108. For instance, building block components 134 and assets of the design library are stored in the cloud inventory entity. Expert developers and designers that are onboarded by onboarding system 116 may have profiles stored in the cloud inventory module 168. Further, the cloud inventory module 168 may store funds that are managed by the cloud wallet 166. The cloud inventory module 168 may store various software packages that are used by users, expert developers, and designers to produce a software product.

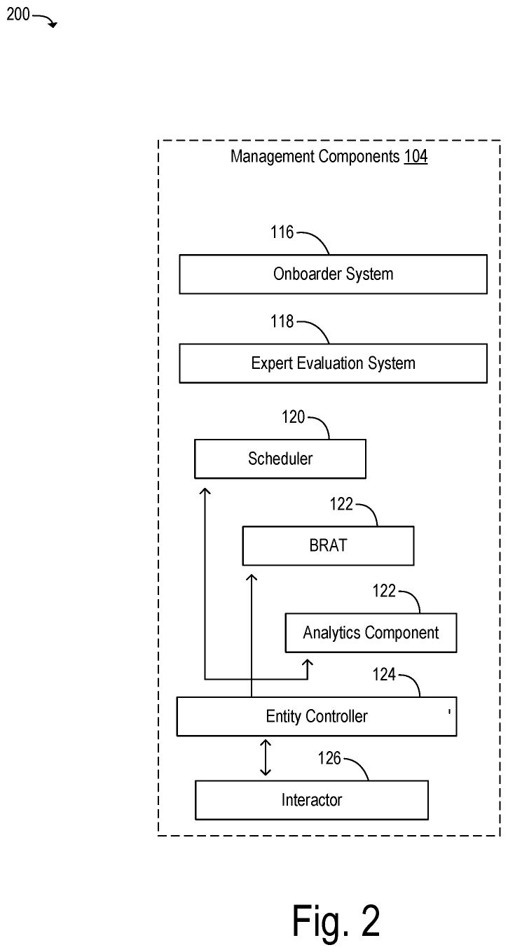

Referring to FIG. 2, FIG. 2 is a schematic 200 illustrating an embodiment of the management components 104 of the software building system 100. The management components 104 provide for continuous assessment and management of a project through its entities and systems. The central hub of the management components 104 is entity controller 126. In an exemplary embodiment, core functionality of the entity controller 126 system comprises the following: display computer readable specifications configurations, provide statuses of all computer readable specifications, provide toolkits within each computer readable specification, integration of the entity controller 126 with tracker 146 and the onboarding system 116, integration code repository for repository creation, code infrastructure creation, code management, and expert management, customer management, team management, specification and demonstration call booking and management, and meetings management.

In an exemplary embodiment, the computer readable specification configuration status includes customer information, requirements, and selections. The statuses of all computer readable specifications may be displayed on the entity controller 126, which provides a concise perspective of the status of a software project. Toolkits provided in each computer readable specification allow expert developers and designers to chat, email, host meetings, and implement 3rd party integrations with users. Entity controller 126 allows a user to track progress through a variety of features including but not limited to tracker 146, the UI engine 142, and the onboarding system 116. For instance, the entity controller 126 may display the status of computer readable specifications as displayed in tracker 146. Further, the entity controller 126 may display a list of experts available through the onboarding system 116 at a given time as well as ranking experts for various jobs.

The entity controller 126 may also be configured to create code repositories. For example, the entity controller 126 may be configured to automatically create an infrastructure for code and to create a separate code repository for each branch of the infrastructure. Commits to the repository may also be managed by the entity controller 126.

Entity controller 126 may be integrated into scheduler 120 to determine a timeline for jobs to be completed by developer experts and designers. The BRAT 122 system may be leveraged to score and rank experts for jobs in scheduler 120. A user may interact with the various entity controller 126 features through the analytics component 124 dashboard. Alternatively, a user may interact with the entity controller 126 features via the interactive conversation in the interactor 112 system.

Entity controller 126 may facilitate user management such as scheduling meetings with expert developers and designers, documenting new software such as generating an API, and managing dependencies in a software project. Meetings may be scheduled with individual expert developers, designers, and with whole teams or portions of teams.

Machine learning algorithms may be implemented to automate resource allocation in the entity controller 126. In an exemplary embodiment, assignment of resources to groups may be determined by constrained optimization by minimizing total project cost. In various embodiments a health state of a project may be determined via probabilistic Bayesian reasoning whereby a causal impact of different factors on delays using a Bayesian network are estimated.

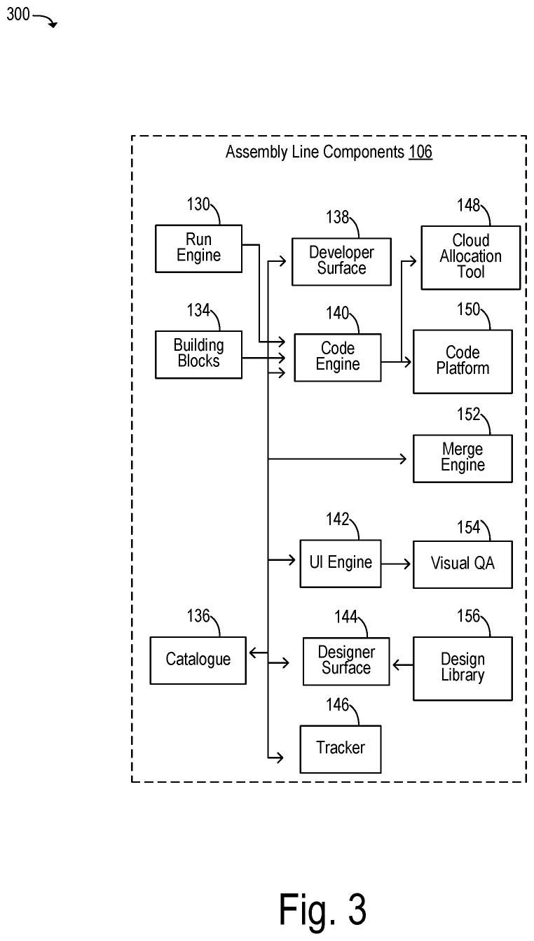

Referring to FIG. 3, FIG. 3 is a schematic 300 illustrating an embodiment of the assembly line components 106 of the software building system 100. The assembly line components 106 support the various features of the management components 104. For instance, the code platform 150 is configured to facilitate user management of a software project. The code engine 140 allows users to manage the creation of software by standardizing all code with pretested building block components. The building block components contain LSTs that identify the customizable portions of the building block components 134.

The machine readable specifications may be generated from user specifications. Like the building block components, the computer readable specifications are designed to be managed by a user without software management experience. The computer readable specifications specify project goals that may be implemented automatically. For instance, the computer readable specifications may specify one or more goals that require expert developers. The scheduler 120 may hire the expert developers based on the computer readable specifications or with direction from the user. Similarly, one or more designers may be hired based on specifications in a computer readable specification. Users may actively participate in management or take a passive role.

A cloud allocation tool 148 is used to determine costs for each computer readable specification. In an exemplary embodiment, a machine learning algorithm is used to assess computer readable specifications to estimate costs of development and design that is specified in a computer readable specification. Cost data from past projects may be used to train one or more models to predict costs of a project.

The developer surface 138 system provides an easy to set up platform within which expert developers can work on a software project. For instance, a developer in any geography may connect to a project via the cloud system 162 and immediately access tools to generate code. In one example, the expert developer is provided with a preconfigured IDE as they sign into a project from a web browser.

The designer surface 144 provides a centralized platform for designers to view their assignments and submit designs. Design assignments may be specified in computer readable specifications. Thus, designers may be hired and provided with instructions to complete a design by an automated system that reads a computer readable specification and hires out designers based on the specifications in the computer readable specification. Designers may have access to pretested design components from a design library 156. The design components, like building block components, allow the designers to start a design from a standardized design that is already functional.

The UI engine 142 may automatically convert designs into web ready code such as React code that may be viewed by a web browser. To ensure that the conversion process is accurate, the visual QA 154 system may evaluate screens generated by the UI engine 142 by comparing them with the designs that the screens are based on. In an exemplary embodiment, the visual QA 154 system does a pixel to pixel comparison and logs any discrepancies to be evaluated by an expert developer.

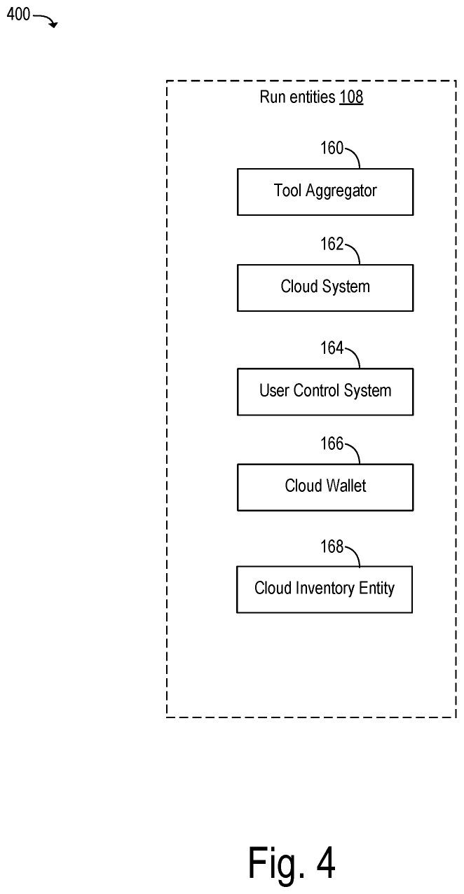

Referring to FIG. 4, FIG. 4 is a schematic 400 illustrating an embodiment of the run entities 108 of the software building system. The run entities 108 provides a user with 3rd party tools and services, inventory management, and cloud services in a scalable system that can be automated to manage a software project. In an exemplary embodiment, the run entities 108 is a cloud-based system that provides a user with all tools necessary to run a project in a cloud environment.

For instance, the tool aggregator 160 automatically subscribes with appropriate 3rd party tools and services and makes them available to a user without a time consuming and potentially confusing set up. The cloud system 162 connects a user to any of the features and services of the software project through a remote terminal. Through the cloud system 162, a user may use the user control system 164 to manage all aspects of a software project including conversing with an intelligent AI in the interactor 112 system, providing user specifications that are converted into computer readable specifications, providing user designs, viewing code, editing code, editing designs, interacting with expert developers and designers, interacting with partners, managing costs, and paying contractors.

A user may handle all costs and payments of a software project through cloud wallet 166. Payments to contractors such as expert developers and designers may be handled through one or more accounts in cloud wallet 166. The automated systems that assess completion of projects such as tracker 146 may automatically determine when jobs are completed and initiate appropriate payment as a result. Thus, accounting through cloud wallet 166 may be at least partially automated. In an exemplary embodiment, payments through cloud wallet 166 are completed by a machine learning AI that assesses job completion and total payment for contractors and/or employees in a software project.

Cloud inventory module 168 automatically manages inventory and purchases without human involvement. For example, cloud inventory module 168 manages storage of data in a repository or data warehouse. In an exemplary embodiment, it uses a modified version of the knapsack algorithm to recommend commitments to data that it stores in the data warehouse. Cloud inventory module 168 further automates and manages cloud reservations such as the tools providing in the tool aggregator 160.

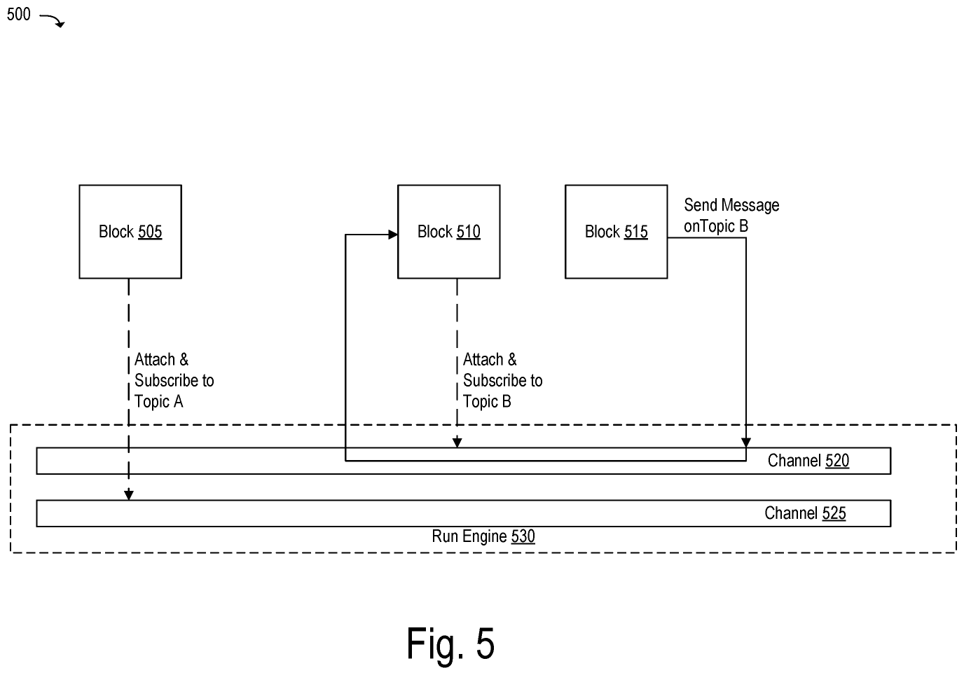

Referring to FIG. 5, FIG. 5 is a schematic 500 illustrating an embodiment of a run engine 530 of the disclosed subject matter facilitating communication between various components of a device application. The run engine 530 serves as a backbone for the device application. It provides infrastructure that facilitates execution of functions for various components. Further, the run engine 530 facilitates interoperability between various components in the run engine 530. In an exemplary embodiment, the components in the run engine 530 are configured to be ignorant of one another and operate independently. In order to coordinate components that operate independently, the run engine 530 performs an interim messaging function whereby components execute commands and functions responsive to messages that are sent through the run engine.

In an exemplary embodiment, messages in the run engine 530 are transmitted by adapters. One or more adapters may be configured to translate instructions from one component to the next. One or more adapters may be configured to broadcast messages responsive to a single component. Likewise, one adapter may translate and broadcast messages from multiple components.

The blocks shown in the schematic 500 may represent component entities that broadcast messages to the run engine 530. In an exemplary embodiment, each block may represent a combination of a component and one or more adapters. In an exemplary embodiment, each block may comprise one or more components and one or more adapters that transmit or receive a message as a single unit. In various embodiments, messages in the run engine may be broadcast over channels, which are announcement streams. The run engine 530 may include one or more channels. In cases where there is more than one channel, a block may subscribe to one or more channels to “listen” for a message. The term listen, are used herein, refers to recording a stream of data to determine when the stream of data triggers a condition. For example, the condition may be that consecutive characters in the stream of data are equal to a string. In the example, the string may be “OPEN_MENU_SCREEN”. Messages that are broadcast on any other channel will not be received. For example, block 505 is subscribed to channel 525. The act of subscribing to a channel may be performed by an adapter or component. For example, an adapter may execute a command that causes it to listen to the announcement stream on a specific channel.

As shown in the schematic 500, block 505 is subscribed to topic A on channel 525. A specific topic on the channel may be a specific stream of characters or the like. For example, topic A may represent an action or function that is executed on the device application. An example of the character stream may be “BROWSER_SELECTED”. Accordingly block 505 would listen for a message of “BROWSER_SELECTED” on Channel 525 and may be configured to perform an action responsive to the message.

In another example, a block may be configured to listen for a message from another block. As shown in the schematic 500, block 510 is subscribed to channel 520 to listen for topic B. When block 515 then broadcasts topic B on channel 520, as shown in the schematic 500, block 510 will receive the message. Block 510 may be configured to perform one or more actions or execute one or more functions responsive to receiving the message.

Because blocks are configured to operate independently of one another, additional blocks may be added to the device application without changing a functionality of any other blocks. Accordingly, adding a block to the device application shown in the schematic 500 will not change or modify the functionality of the existing blocks. Further, removing one or more blocks from the device application will not modify the functionality of any remaining blocks.

In various embodiments, each block comprises a combination of one or more components and one or more adapters. Interoperability between various components may be modified via logic. In an exemplary embodiment, logic may be handled by adapters. An example of logic may be to configure an adapter to broadcast a message responsive to execution of a function by a component. Another example of logic may be to configure an adapter to cause a component to execute one or more functions responsive to receiving a message that is broadcast on a channel of the run engine 530.

Accordingly, components that comprise one or more functions may be developed independently of one another. The components may then be assembled into the device application. Adapters may be used to manage operability of the components via logic programmed into the adapters. In an exemplary embodiment, a library of components may be maintained whereby one or more components from the library of components may be selected and quickly assembled into a device application. The only programming necessary would be in adding logic to the adapters.

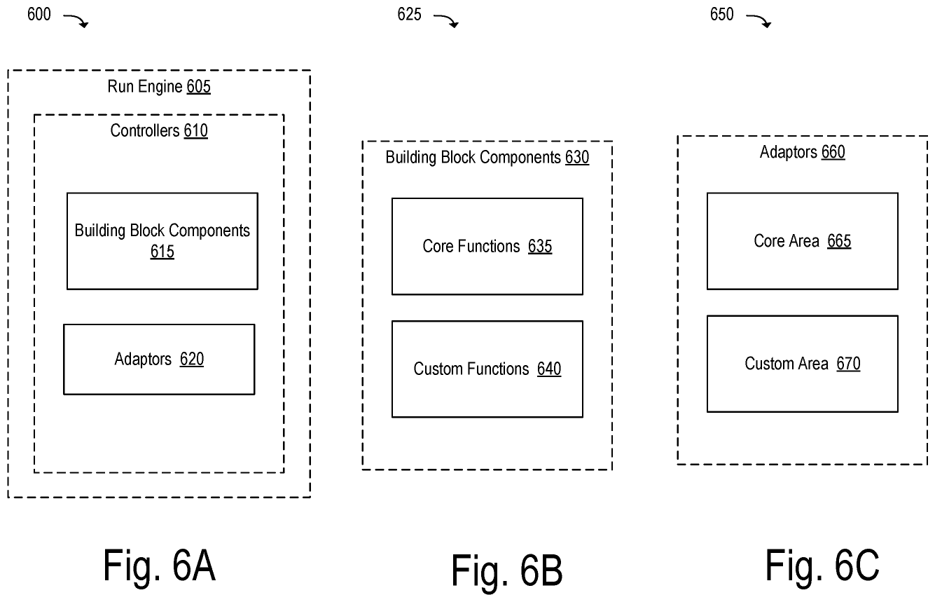

Referring to FIG. 6A, FIG. 6A is a schematic 600 for an embodiment of a run engine 605 of the disclosed subject matter. The run engine 605 facilitates the transmission of messages within the software application. Building block components 615 that make up core features of a software application are operated by the run engine 605. In various embodiments, a developer may select a multitude of building block components 615 depending on features that are desired for the software application. The run engine 605 may contain any number of building block components 615 to implement any number of features.

In an exemplary embodiment, the run engine 605 comprises one or more controllers 610. Each controller 610 may comprise one or more building block components 615 and one or more adapters 620. The controller 610 may include logic that determines an interaction between building block components 615. For instance, a controller 610 may comprise a building block component 615 that includes the functions for logging a user into a server. Logic in the controller 610 may determine when those functions are implemented. Logic in the controller may also help determine one or more functions that are implemented after the login is implemented.

The building block components 615 are software modules that comprise one or more functions for implementing features in a software application. Each building block component 615 in the controller 610 may operate independently of each other building block component 615 in the controller 610. Accordingly, removing or adding one or more building block components 615 from the controller 610 or from the software application does not impact a functionality of the other building block components 615 in the software application or controller 610. Building block components 615 may be developed in any order or in parallel in a software application. For instance, multiple developers may concurrently develop one or more building block components 615 for the same software application.

The controller 610 may include one or more adapters 620 that enable the sending and receiving of messages to and from building block components 615. Building block components 615 may communicate with other building block components 615 via the sending of messages. Adapters 620 may be used to generate messages based on output from a building block component 615. Adapters 620 may also be used to receive messages for one or more building block components 615. A single adapter 620 may be implemented to send and receive messages for one or more building block components 615.

In an example of use, when a building block component 615, which is configured to log a user into an application, completes a login, an adapter 620 may be configured to broadcast a message that a login is complete. Another building block component 615, which is configured to open a startup screen may be activated based on the login complete message. Accordingly, an adapter may receive the login complete message and activate a building block component 615 to open the start of screen.

Referring to FIG. 6B, FIG. 6B is a schematic 625 for an embodiment of a building block component 630 that may be implemented in the disclosed subject matter. A software application may include one or more building block components 630. Each building block component 630 operates independently of the other building block components 630, but may be configured to send and receive messages to and from the other building block components 630.

Each building block component 630 comprises software functions that enable one or more features in the software application. For instance, a building block component 630 for implementing a clickable button may include one or more functions, that when executed, implement a clickable button utility. Each building block component 630 may comprise one or more core functions 635 and one or more custom functions 640. The core functions 635 may be configured to be un-editable in a building block component 630. A developer may be encouraged to include one or more custom functions 640 in a building block component 630 to implement functionality or features that are specific to their software application.

Each of the core functions 635 and custom functions 640 may be configured so as not to depend on functionality from other building block components 630. Thus, each of the building block components 630 may be developed independently. This may allow for rapid development as building block components 630 may be developed concurrently by multiple developers. Further, building block components 630 may be configured to implement specific features in an application that are common to multiple applications.

Thus, a single building block component 630 may be developed to be used as a utility. A developer may choose to include a preconfigured building block component 630 based on features that the developer desires in the software application. A completed software application may be further developed by adding additional building block components 630 because the additional building block components 630 do not depend on any of the existing building block components 630. Further, adding additional building blocks to a software application will not break any of the functionality of the software application.

Referring to FIG. 6C, FIG. 6C is a schematic 650 for an embodiment of an adapter 660 that may be implemented in the disclosed subject matter. Building block components 630 may be configured not to depend on any functions of other building block components 630. However, a building block component may be configured to receive messages that are generated by another building block component 630. The transmission of messages from one building block component 630 to another is facilitated by the adapters 660.

Adapters 660 allow for building block components 630 to be interconnected without being interdependent on functionality. A building block component 630 may generate a message that is to be received by another building block component 630. An adapter 660 may be configured to broadcast a message from one building block component 630 and another adapter 660 may be configured to listen for the message. For example, the adapter 660 may be configured to subscribe to one or more messages, where subscribing puts the adapter in a state that causes the adapter 660 to perform an action when it receives the message. The terms listening and subscribing, as used herein, are used interchangeably as they apply to the adapters 660.

In various embodiments, an adapter may be configured to broadcast data that is nested in a message. For instance, an adapter may broadcast a message to open a check out screen for a shopping application. The message to open the check out screen may be received by an adapter 660 that executes one or more functions on a building block component 630 that operates the checkout screen. The message may further include nested data such as one or more shopping items that the user selected. The nested data may be received by the adapter 660 along with the message to be transmitted to the building block component 630 that implements the checkout screen.

Like building block components 630, the adapters 660 may each include a core area 665 and a custom area 670. The core area 665 may include one or more functions that facilitate sending and receiving messages with the adapter 660. In various embodiments, an adapter may have a listen function whereby any adapter may be configured to listen for one or more messages that may be transmitted within the run engine 605. In an example of use, an adapter 660 is configured to listen for a “LOGIN_COMPLETE” message. When the adapter 660 receives the “LOGIN_COMPLETE” message, it executes one or more functions in a building block component 630.

The custom area 670 in each adapter 660 may be utilized to implement logic in a software application. For example, the custom area may be edited to execute one or more functions of a building block upon receiving a message from the run engine 605. In another example, logic may be implemented to broadcast one or more messages responsive to execution of functions in a building block component 630.

In various embodiments, the customer logic area may be configurable by a machine readable specification. For example, a machine readable specification may specify that execution of a function by a first building block component triggers execution of a function by a second building block component. Accordingly, a computer system may automatically insert logic into a first adapter that causes the adapter to transmit a message responsive to the first building block component executing the function. The machine readable specification may further insert logic into a second adapter that causes the second adapter to listen for the message and cause the second building block component to execute a function responsive to receiving the message.

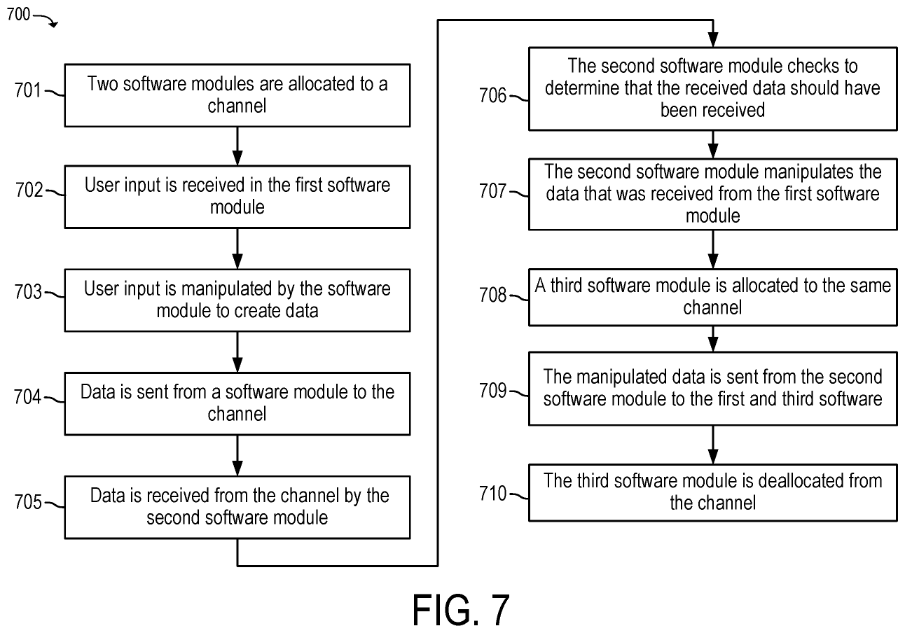

Referring to FIG. 7, FIG. 7 is a flow diagram 700 illustrating an embodiment of the disclosed subject matter. The term software module, as used herein, may refer to any component, function, class, or the like that is configured to perform a functionality in a device application. The term allocate, as used herein, may refer to configuring a software module to send and receive messages on a channel. In an exemplary embodiment, two software modules are allocated to a channel at step 701. For example, these two software modules could be a dedicated login module, and a module which pulls profile data from a database, and would be subscribed to the same “login” channel. At step 702, a user input is received in the first software module. For example, a user may input login information into a prompt provided by the first software module.

At step 703, the user input is manipulated by the software module to create data. For example, a login software module could use a provided username and password to generate data associated with a login authorization. In step 704, data is sent from the first software module to the channel. In step 705 data is received from the channel by the second software module. For example, a login software module could send an authorization token to another software module which pulls relevant profile information from a database. I

n step 706, the first software module checks to determine that the sent data have been received. For example, the first software module could check that the data received from the login module is an authorization token. In step 707, the second software module manipulates the data that was received from the first software module. For example, the second module could convert the authorization token into relevant profile data. In step 708 a third software module is allocated to the same channel. For example, a display software module could be newly subscribed to the login module.

In step 709, the manipulated data is sent from the second software module to the first and third software modules. For example, the display module could then accept the profile data so it can be displayed. In step 710, the third software module is deallocated from the channel. For example, if the display module does not require additional information from the login channel, it could unsubscribe from the channel and stop receiving information from the other software modules in the login channel.

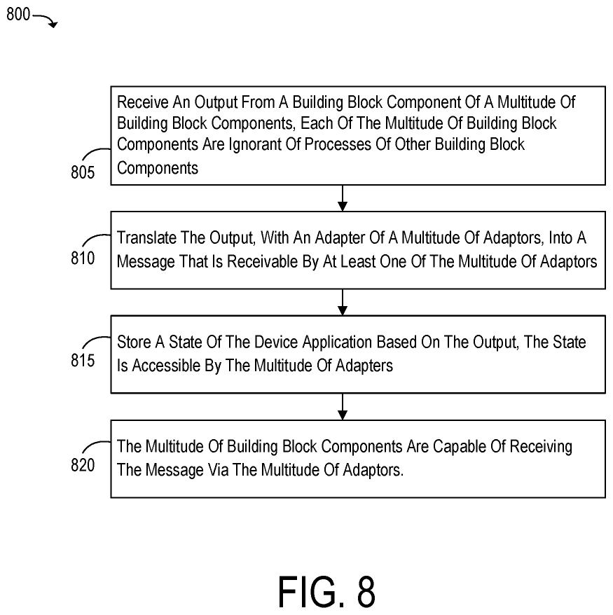

Referring to FIG. 8. FIG. 8 is a flow diagram 800 showing a process for transmitting a communication from a building block component to other building block components. The process may be used to coordinate a functionality of various building block components where the building block components are configured to operate independently of one another. In an exemplary embodiment, a device application, which implements the process, may be quickly built by assembling pre-developed building block components and managing functionality of the building block components using customized logic. For example, logic may be configured in one or more adapters to coordinate a functionality of building block components that have been assembled into a device application.

At step 805, the process may receive an output from a building block component of a multitude of building block components. Each of the multitude of building block components are ignorant of processes of other building block components. As stated above, the term ignorant refers to the functionality of the building block components whereby they operate independently of one another without dependencies on other building block components. Instead of being dependent on one another, building block components may be coordinated via adapters that send and receive messages through the run engine. In various embodiments, the output from the building block component may be a text or numeric value that is generated responsive to an execution of a function. For example, a function may return a value of “1” responsive to executing the function.

At step 810, the process may translate the output, with an adapter of a multitude of adapters, into a message that is receivable by at least one of the multitude of adapters. In an exemplary embodiment, the adapter generates a message responsive to execution of a function by the building block component. The multitude of adapters may comprise one or more adapters in a device application.

At step 815, the process may store the state of the building block component based on output. The state is accessible by the multitude of adapters. In various embodiments, the run engine may store the state and output the state responsive to a request from any of the multitude of adapters. For example, an adapter may request a login state of the device application. The run engine could respond with a “LOGGED_IN” or “NOT_LOGGED_IN” message to the adapter.

At step 820, the multitude of building block components are capable of receiving the message via the multitude of adapters. For example, any one of the multitude of adapters may receive the message and transmit it to one or more of the multitude of building block components. More than one of the multitude of adapters may receive the message and each adapter that receives the message may transmit the message to one or more building block components. In an example of transmitting the message to one or more building block components, an adapter may trigger a function on a building block component to be executed responsive to receiving the message. Each adapter may include custom logic that determines which messages each building block component responds to and which functions are executed responsive to receiving the message. Variations of functionality of the building block components, responsive to the message, may be further coded into the logic.

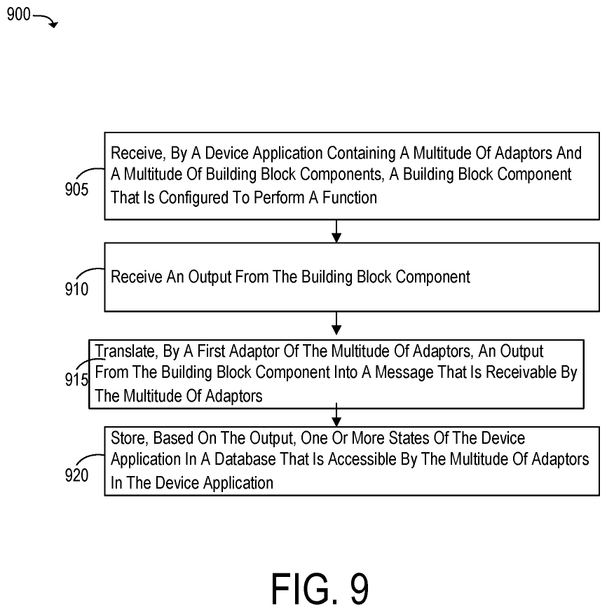

Referring to FIG. 9. FIG. 9 is a flow diagram 900 illustrating a device application that incorporates a new building block component. In various embodiments, the process may be implemented to add or incorporate a building block component to a device application with minimal programming. Because each building block component is configured to operate independently of other building block components, a new building block component may be added to a device application without modifying the functionality of the other building block components.

At step 905 the process may receive, by a device application containing a multitude of adapters and a multitude of building block components, a building block component that is configured to perform a function. The building block component is not limited by the type of function. Examples of the function may include modifying a display of device application, including a new screen for the device application such as a browsing screen, and adding functionality for a social media site such as LinkedIn or Facebook. The building block component may be received by appending it to a file containing one or more other building block components. In another embodiment, the building block may be received by including an additional file to the device application. In an exemplary embodiment, an adapter may be received along with the building block component where the adapter includes logic that is configured to allow the building block component to exchange messages with other building block components in the device application.

At step 910, the process may receive an output from the building block component. In various embodiments, the output may be a value comprising a number, text, character, Boolean, or the like. In an example of use, the output may be generated as a return value responsive to execution of a function.

At step 915, the process may translate, by an adapter of the multitude of adapters, an output from the building block component into a message that is receivable by the multitude of adapters. The translating may comprise generating a message responsive to receiving the output from the building block component. For example, the adapter may generate a string responsive to receiving the output from the building block component. The message may take any form that is receivable by a part of the device application. Portions of the device application that may receive the message may include the run engine and another adapter. For example, one or more other adapters may be configured to listen for the message that is generated by the adapter. Likewise, the run engine may also be configured to listen for the message and perform one or more actions such as store a state of the device application. For example, the run engine may change a screen state of device application whenever it receives a message to navigate to a new screen.

At step 920, the process may store, based on the output, one or more states of the device application in a database that is accessible by the multitude of adapters in the device application. In an exemplary embodiment, the run engine may broadcast one or more states responsive to a request from any one of the multitude of adapters. For example, an adapter may request the screen state of the device application whereby the run engine would broadcast the current screen state of the device application.

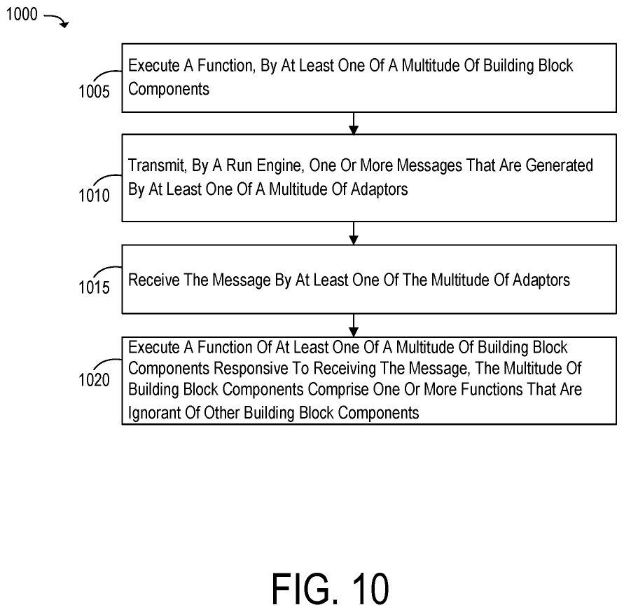

Referring to FIG. 10, FIG. 10 is a flow diagram 1000 showing how building block components, that are ignorant of one another, may execute functions responsive to other building block components. At step 1005, the process may execute a function, by at least one of a multitude of building block components. The function may comprise any function that may be executed by a building block component such as logging in a user, navigating screens in the device application, and connecting the device application to a third-party service. Responsive to executing the function, one or more adapters may be configured to perform one or more actions such as broadcasting a message to device application or causing one or more building block components to implement one or more additional functions.

At step 1010, the process may transmit, by the run engine, one or more messages that are generated by at least one of a multitude of adapters. For example, an adapter that is configured to respond to the function from step 1005, may be configured to transmit a message to the run engine. The run engine may transmit the message on a channel that is receivable by one or more adapters that are subscribed to the channel.

At step 1015, the process may receive the message by at least one of the multitude of adapters. In an exemplary embodiment, one or more adapters may subscribe to the channel to which the run engine may broadcast the message. By subscribing, the one or more adapters may listen for the message on the channel. In an exemplary embodiment, listening for message on the channel comprises recording an announcement stream and triggering a condition when consecutive characters of the announcement stream match a string of characters. For example, if an adapter is listening for the message “STARTUP” on a channel, the adapter may record all characters on a channel and trigger a condition only when a set of seven consecutive characters are equal to the string “STARTUP”.

At step 1020, the process may execute a function of at least one of a multitude of building block components responsive to receiving the message. The multitude of building block components, which comprise one or more functions, are ignorant of other building block components. For example, the adapter that received the message may trigger one or more building block components to execute the function. Custom logic may be easily modified in the adapter to change the function that is executed and ultimately change the functionality of the device application. Accordingly, the device application may be easily coded by modifying logic and adapters and using pre-existing building block components.

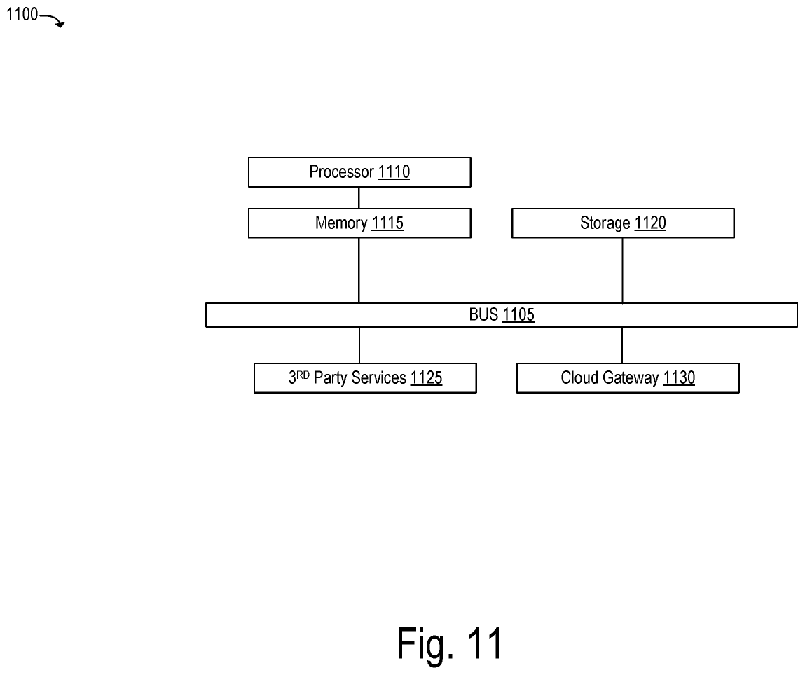

Referring to FIG. 11, FIG. 11 is a schematic illustrating a computing system 1100 that may be used to implement various features of embodiments described in the disclosed subject matter. The terms components, entities, modules, surface, and platform, when used herein, may refer to one of the many embodiments of a computing system 1100. The computing system 1100 may be a single computer, a co-located computing system, a cloud-based computing system, or the like. The computing system 1100 may be used to carry out the functions of one or more of the features, entities, and/or components of a software project.

The exemplary embodiment of the computing system 1100 shown in FIG. 11 includes a bus 1105 that connects the various components of the computing system 1100, one or more processors 1110 connected to a memory 1115, and at least one storage 1120. The processor 1110 is an electronic circuit that executes instructions that are passed to it from the memory 1115. Executed instructions are passed back from the processor 1110 to the memory 1115. The interaction between the processor 1110 and memory 1115 allow the computing system 1100 to perform computations, calculations, and various computing to run software applications.

Examples of the processor 1110 include central processing units (CPUs), graphics processing units (GPUs), field programmable gate arrays (FPGAs), complex programmable logic devices (CPLDs), and application specific integrated circuits (ASICs). The memory 1115 stores instructions that are to be passed to the processor 1110 and receives executed instructions from the processor 1110. The memory 1115 also passes and receives instructions from all other components of the computing system 1100 through the bus 1105. For example, a computer monitor may receive images from the memory 1115 for display. Examples of memory include random access memory (RAM) and read only memory (ROM). RAM has high speed memory retrieval and does not hold data after power is turned off. ROM is typically slower than RAM and does not lose data when power is turned off.

The storage 1120 is intended for long term data storage. Data in the software project such as computer readable specifications, code, designs, and the like may be saved in a storage 1120. The storage 1120 may be stored at any location including in the cloud. Various types of storage include spinning magnetic drives and solid-state storage drives.

The computing system 1100 may connect to other computing systems in the performance of a software project. For instance, the computing system 1100 may send and receive data from 3^{rd} party services such as Office 365 and Adobe. Similarly, users may access the computing system 1100 via a cloud gateway 1130. For instance, a user on a separate computing system may connect to the computing system 1100 to access data, interact with the run entities 108, and even use 3^{rd} party services 1125 via the cloud gateway.

Many variations may be made to the embodiments of the software project described herein. All variations, including combinations of variations, are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

1. A method for operating a device application, the method comprising:
receiving an output from a building block component of a multitude of building block components, each of the multitude of building block components are ignorant of processes of other building block components;
translating the output, with a component adapter of a multitude of adaptors, into a message that is receivable by at least one of the multitude of adaptors;
storing a state of the device application based on the output, the state is accessible by the multitude of adapters; and
the multitude of building block components are capable of receiving the message via the multitude of adaptors.

2. The method of claim 1, wherein the multitude of adaptors comprise a customer logic section that is configurable to execute one or more functions of the multitude of building block components.

3. The method of claim 1, wherein the message is transmitted on a channel that is selectable by the adaptor.

4. The method of claim 3, further comprising subscribing, by at least one of the multitude of adaptors, to a topic on the channel; and
wherein the message comprises the topic.

5. The method of claim 2, wherein the custom logic section is configurable to execute a function of at least one of the multitude of building block components responsive to receiving the message.

6. The method of claim 5, wherein the custom logic section is configurable by a machine readable specification.

7. The method of claim 1, further comprising executing, by one of the multitude of adaptors, a function of one of the multitude of building block components responsive to receiving the message.

8. A computer system configured to develop a device application, the computer system comprising:
a processor coupled to a memory, the processor configured to:
receive an output from a building block component of a multitude of building block components, each of the multitude of building block components are ignorant of processes of other building block components;
translate the output, with a component adapter of a multitude of adaptors, into a message that is receivable by at least one of the multitude of adaptors; and
store a state of the device application based on the output, the state is accessible by the multitude of adapters;
the multitude of building block components are capable of receiving the message via the multitude of adaptors.

9. The computer system of claim 8, wherein the multitude of adaptors comprise a customer logic section that is configurable to execute one or more functions of the multitude of building block components.

10. The computer system of claim 8, wherein the message is transmitted on a channel that is selectable by the component adaptor.

11. The computer system of claim 10, wherein the processor is further configured to subscribe, by at least one of the multitude of adaptors, to a topic on the channel; and
wherein the message comprises the topic.

12. The computer system of claim 9, wherein the custom logic section is configurable to execute a function of at least one of the multitude of building block components responsive to receiving the message.

13. The computer system of claim 12, wherein the custom logic section is configurable by a machine readable specification.

14. The computer system of claim 8, wherein the processor is further configured to execute, by one of the multitude of adaptors, a function of one of the multitude of building block components responsive to receiving the message.

15. A computer readable storage medium having data stored therein representing software executable by a computer, the software comprising instructions that, when executed, cause the computer readable storage medium to perform:
receiving an output from a building block component of a multitude of building block components, each of the multitude of building block components are ignorant of processes of other building block components;
translating the output, with a component adapter of a multitude of adaptors, into a message that is receivable by at least one of the multitude of adaptors;
storing a state of a device application based on the output, the state is accessible by the multitude of adapters; and
the multitude of building block components are capable of receiving the message via the multitude of adaptors.

16. The computer readable storage medium of claim 15, wherein the multitude of adaptors comprise a customer logic section that is configurable to execute one or more functions of the multitude of building block components.

17. The computer readable storage medium of claim 15, wherein the message is transmitted on a channel that is selectable by the adaptor.

18. The computer readable storage medium of claim 17, wherein the instructions further cause the computer readable storage medium to perform subscribing, by at least one of the multitude of adaptors, to a topic on the channel; and
wherein the message comprises the topic.

19. The computer readable storage medium of claim 16, wherein the custom logic section is configurable to execute a function of at least one of the multitude of building block components responsive to receiving the message.

20. The computer readable storage medium of claim 15, wherein the instructions further cause the computer readable storage medium to perform executing, by one of the multitude of adaptors, a function of one of the multitude of building block components responsive to receiving the message.
